(19) United States
(12) Patent Application Publication
(10) Pub. No.: US 2020/0380630 A1
(43) Pub. Date: Dec. 3, 2020

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventors: Kenji FUJIHARA, Nagoya-shi (JP); Akitoshi JIKUMARU, Nisshin-shi (JP); Mizuki KIUCHI, Toyota-shi (JP); Takashi YAMAZAKI, Nagoya-shi (JP); Atsuko KOBAYASHI, Nagoya-shi (JP); Masayuki GOTO, Nagoya-shi (JP)

(73) Assignee: TOYOTA JIDOSHA KABUSHIKI KAISHA, Toyota-shi (JP)

(21) Appl. No.: 16/837,018

(22) Filed: Apr. 1, 2020

(30) Foreign Application Priority Data
May 27, 2019 (JP) 2019-098662

(51) Int. Cl. G06Q 50/30; G06Q 10/06; G05D 1/00; G05D 1/02; B64F 1/30

(52) U.S. Cl. CPC G06Q 50/30; G06Q 10/06315; G05D 1/0088; G05D 2201/0213; B64F 1/30; G06Q 2240/00; G05D 1/0212

(57) ABSTRACT

An information processing apparatus includes a controller configured to acquire information about a first airplane and a second airplane in a case where a user who makes an airplane transfer in an airport makes a request to use an autonomously traveling vehicle when the user moves from the first airplane to the second airplane, match the user with the vehicle based on the information about the first airplane and the second airplane, and generate an operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle.

### INCORPORATION BY REFERENCE

The disclosure of Japanese Patent Application No. 2019-098662 filed on May 27, 2019 including the specification, drawings and abstract is incorporated herein by reference in its entirety.

### BACKGROUND

### 1. Technical Field

The disclosure relates to an information processing apparatus, an information processing method, and a program.

### 2. Description of Related Art

A mobile office built by installing office supplies in an automobile is known (for example, refer to Japanese Unexamined Patent Application Publication No. 09-183334 (JP 09-183334 A). With such a vehicle, it is possible for a user to carry out office work even while the vehicle is traveling.

### SUMMARY

In the case of the above-described related art, when a user makes an airplane transfer at an airport, the user needs to manage a time of arrival at an airplane to which the user transfers. The disclosure provides an information processing apparatus, an information processing method, and a program with which it is possible to simplify making an airplane transfer by means of an autonomously traveling vehicle.

A first aspect of the disclosure relates to an information processing apparatus including a controller. The controller is configured to acquire information about a first airplane from which a user transfers and information about a second airplane to which the user transfers in a case where the user who makes an airplane transfer in an airport makes a request to use an autonomously traveling vehicle when the user moves from the first airplane to the second airplane, match the user with the vehicle based on the information about the first airplane and the information about the second airplane, and generate an operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle.

A second aspect of the disclosure relates to an information processing method. The information processing method includes causing a computer to acquire information about a first airplane from which a user transfers and information about a second airplane to which the user transfers in a case where the user who makes an airplane transfer in an airport makes a request to use an autonomously traveling vehicle when the user moves from the first airplane to the second airplane, match the user with the vehicle based on the information about the first airplane and the information about the second airplane, and generate an operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle.

A third aspect of the disclosure relates to a program. The program causes a computer to acquire information about a first airplane from which a user transfers and information about a second airplane to which the user transfers in a case where the user who makes an airplane transfer in an airport makes a request to use an autonomously traveling vehicle when the user moves from the first airplane to the second airplane, match the user with the vehicle based on the information about the first airplane and the information about the second airplane, and generate an operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle.

A fourth aspect of the disclosure relates to a computer-readable storage medium non-transitorily storing the above-described program.

According to the aspects of the disclosure, it is possible to simplify making an airplane transfer by means of an autonomously traveling vehicle.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram illustrating a schematic configuration of an autonomous driving system according to an embodiment;

FIG. 2 is a diagram for describing the moving routes of vehicles at the time of airplane transfers made by users;

FIG. 3 is a block diagram schematically illustrating an example of the configurations of a vehicle, a user terminal, and a server constituting the autonomous driving system according to the embodiment;

FIG. 4 is a diagram illustrating an example of the functional configuration of the server;

FIG. 5 is a diagram illustrating a table configuration of vehicle information;

FIG. 6 is a diagram illustrating a table configuration of airplane information;

FIG. 7 is a diagram illustrating a table configuration of request information;

FIG. 8 is a diagram illustrating an example of the functional configuration of the vehicle;

FIG. 9 is a diagram illustrating an example of the functional configuration of the user terminal;

FIG. 10 is a diagram illustrating an example of a screen that is displayed on an output unit of the user terminal when a user makes a request to board the vehicle to make a transfer;

FIG. 11 is an example of a flowchart of a process of matching a user with the vehicle according to the embodiment;

FIG. 12 is an example of a flowchart of a process of causing the vehicle according to the embodiment to travel;

FIG. 13 is a diagram illustrating a table configuration of request information;

FIG. 14 is a diagram illustrating an example of a screen that is displayed on the output unit of the user terminal when a user makes a request to board the vehicle to make a transfer;

FIG. 15 is a diagram illustrating a table configuration of vehicle information; and

FIG. 16 is an example of a flowchart of a process of matching a user with a vehicle according to another embodiment.

### DETAILED DESCRIPTION OF EMBODIMENTS

A vehicle managed by an information processing apparatus according to an embodiment is a vehicle that autonomously travels based on an operation instruction.

The operation instruction is generated such that a user can make an airplane transfer. The vehicle can move the user from a first airplane to a second airplane by moving in accordance with the operation instruction. In addition, by boarding the vehicle, the user can move to the second airplane without managing a boarding time of the second airplane by himself or herself. That is, by boarding the vehicle, the user can move such that the user becomes not late for the boarding time of the second airplane.

A controller acquires information about the first airplane and information about the second airplane. The information about the first airplane and the information about the second airplane are, for example, identification numbers unique to the first airplane and the second airplane. The information about the first airplane and the information about the second airplane are information that is needed to dispose the vehicle and cause the vehicle to travel when the user makes a transfer. The information about the first airplane and the information about the second airplane may be acquired from a terminal carried by the user.

The controller matches the user and the vehicle with each other based on the information about the first airplane and the information about the second airplane. Here, matching the user and the vehicle with each other is setting a combination of the vehicle and the user. The vehicle matched with the user is a vehicle with which the user can transfer from the first airplane to the second airplane. A plurality of users may be matched with the same vehicle.

In addition, the controller generates the operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle. The time at which the user alights from the first airplane and the position where the user alights from the first airplane are acquired based on the information about the first airplane. For example, in a case where the information about the first airplane includes information about a flight number of the airplane, information about an alighting time or an alighting position corresponding to the flight number is acquired from, for example, an external server. In addition, for example, in a case where the information about the second airplane includes information about a flight number, information about a boarding time or a boarding position corresponding to the flight number is acquired from, for example, the external server.

The time at which the user alights from the first airplane and the time at which the user boards the second airplane may range in time to a certain extent. That is, it is sufficient that the time at which the user alights from the first airplane is within a period of time at which the user can alight from the first airplane. Similarly, it is sufficient that the time at which the user boards the second airplane is within a period of time at which the user can board the second airplane. In addition, the position where the user alights from the first airplane and the position where the user board the second airplane may range in distance to a certain extent. That is, it is sufficient that the position where the user alights from the first airplane is within an area around the first airplane where the user can board the vehicle. Similarly, it is sufficient that the position where the user boards the second airplane is within an area where the user can board the second airplane.

Since the vehicle is disposed at the position where the user alights from the first airplane in accordance with the time at which the user alights from the first airplane, the user alights from the first airplane can easily board the vehicle. Meanwhile, since the vehicle is disposed at the position where the user boards the second airplane in accordance with the time at which the user boards the second airplane, the user can easily board the second airplane. Accordingly, it is possible to simplify making a transfer by means of an autonomously traveling vehicle.

In addition, in a case where there is a plurality of users transferring from the first airplane and there is a plurality of the second airplanes to which the users are able to transfer from the first airplane, the controller may match the users with vehicles such that users who transfer to the same second airplane board the same vehicle.

That is, when users are matched with vehicles such that a plurality of users having the same destination board the same vehicle, the users can be moved at the same time. Making a transfer can be simplified for the users at the same time.

In addition, the controller may acquire information about the attribute of the user and may match the user with the vehicle based on the information about the attribute of the user in addition to the information about the first airplane and the information about the second airplane.

The attribute of a user refers to a quality or a characteristic of the user that is used in determination at the time of selection of a vehicle to which the user needs to board. For example, in a case where there are vehicles including a smoking-free vehicle and a smoking-permitted vehicle, information indicating whether a user is a smoker or a non-smoker is acquired as information about the attribute of the user. Then, the user is matched with a vehicle such that a smoker boards a smoking-permitted vehicle and a non-smoker boards a smoking-free vehicle. Since a vehicle is selected in accordance with the attribute of a user in this manner, user convenience is improved. A vehicle matched with a user is a vehicle matching the attribute of the user.

In addition, in a case where there is a plurality of users transferring from the first airplane and there is a plurality of the second airplanes to which the users are able to transfer from the first airplane, the controller may match the users with vehicles such that users who transfer to the same second airplane and have the same attribute board the same vehicle.

That is, when users are matched with vehicles such that a plurality of users having the same destination and have the same attribute board the same vehicle, making a transfer can be simplified and user convenience can be improved.

In addition, the information about the first airplane may include information about the time at which the user alights from the first airplane and information about the position where the user alights from the first airplane and the information about the second airplane may include information about the time at which the user boards the second airplane and information about the position where the user boards the second airplane.

The information above described is information that can be used when the user is caused to board the vehicle at the alighting position at the alighting time for the first airplane and the user is caused to alight from the vehicle at the boarding position at the boarding time of the second airplane. Since the operation instruction of the vehicle is generated based on the above-described information, the user can make an airplane transfer.

Hereinafter, embodiments will be described based on drawings. The configurations in the following embodiments are merely examples and the disclosure is not limited to the configurations in the embodiments. In addition, the following embodiments can be combined with each other as much as possible.

First Embodiment

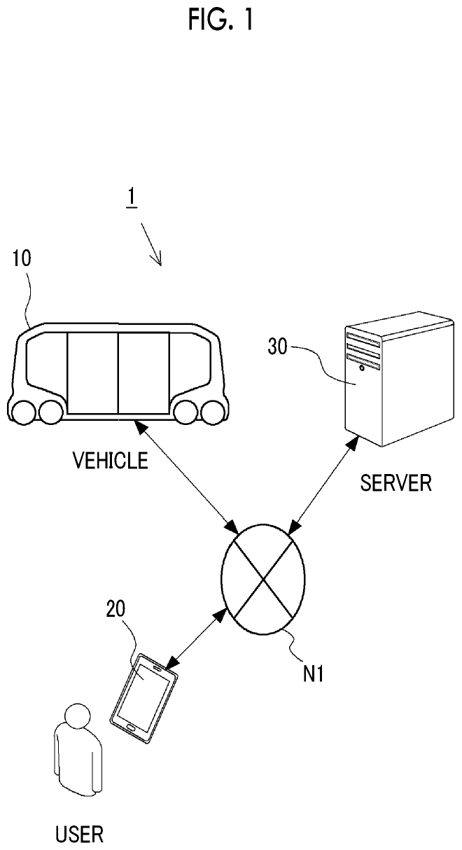

FIG. 1 is a diagram illustrating a schematic configuration of an autonomous driving system 1 according to an embodiment. The autonomous driving system 1 includes, for example, a vehicle 10, a user terminal 20, and a server 30. Note that, the number of vehicles 10 and the number of user terminals 20 may not be one as shown in FIG. 1 and the number of vehicles 10 and the number of user terminals 20 may be two or more. The autonomous driving system 1 shown in FIG. 1 is a system in which the vehicle 10 autonomously travels, with a user being aboard the vehicle 10, from the alighting position of an arriving airplane (first airplane), from which the user transfers, to the boarding position of a departing airplane (second airplane), to which the user transfers, in a case where the user makes an airplane transfer in an airport. That is, the vehicle 10 goes to a position where the user alights from the first airplane to pick up the user and moves to a position where the user boards the second airplane with the user being aboard the vehicle 10. The second airplane that a user alighting from the first airplane boards next may be different for each user. Therefore, for example, in a case where there is a plurality of users transferring from the same first airplane to the same second airplane, the users are matched with vehicles such that the users board the same vehicle together. An operation instruction is transmitted from the server 30 to the vehicle 10 and the vehicle 10 autonomously travels according to the operation instruction.

A user in FIG. 1 is a user who operates the user terminal 20 and is a user who transfers from the first airplane to the second airplane in the airport. Information about the vehicle 10 that the user needs to board is transmitted from the server 30 to the user terminal 20. The user determines which vehicle 10 the user needs to board in accordance with content displayed on the user terminal 20. There may be a plurality of users and there is a plurality of user terminals 20 corresponding to the number of the users.

The vehicle 10, the user terminal 20, and the server 30 are connected to each other via a network N1. The network N1 is a global public communication network such as the Internet and a wide area network (WAN) or other communication networks can be adopted as the network N1. In addition, the network N1 may include a telephone communication network for a cellular phone or the like and a wireless communication network such as WiFi.

Outline of Autonomous Driving System

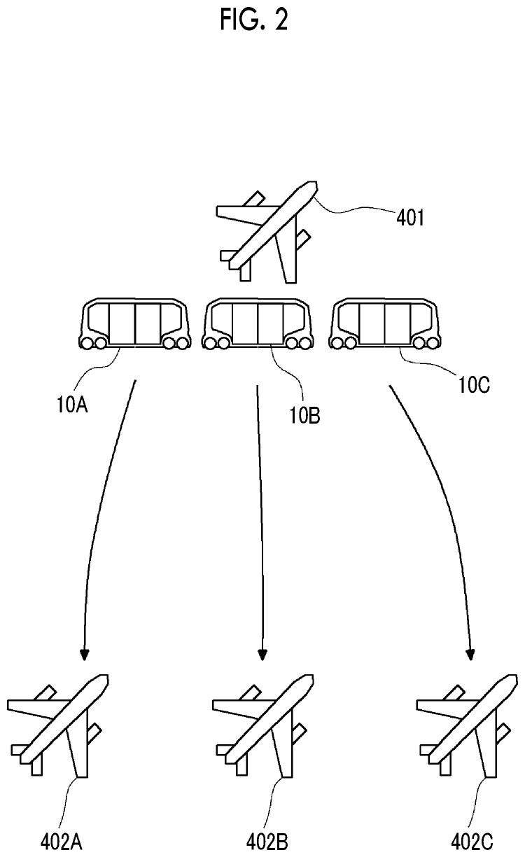

The outline of an autonomous driving system according to the present embodiment will be described. FIG. 2 is a diagram for describing the moving routes of the vehicles 10 at the time of airplane transfers made by users. FIG. 2 shows a case where there are three second airplanes 402A, 402B, 402C to which the users alighting from a first airplane 401 at the alighting position of the first airplane 401 can transfer. Note that, the alighting position is a position where the users alighting from the first airplane 401 can board the vehicles 10 and is an area to which the users can move from the first airplane 401 on foot. The alighting position may be in the vicinity of a trap of the first airplane 401 and may be an exit of the first airplane 401. At the alighting position of the first airplane 401, vehicles 10A, 10B, 10C respectively corresponding to the second airplanes 402A, 402B, 402C are disposed. Note that, hereinafter, in a case where the second airplanes 402A, 402B, 402C are not to be distinguished from each other, the second airplanes 402A, 402B, 402C are simply referred to as “second airplane 402”. In addition, in a case where the vehicles 10A, 10B, 10C are not to be distinguished from each other, the vehicles 10A, 10B, 10C are simply referred to as “vehicle 10”.

A user who transfers from the first airplane 401 to the second airplane 402A can move to the boarding position of the second airplane 402A by boarding the vehicle 10A after alighting from the first airplane 401. Note that, the boarding position is a position where the user boarding the second airplane 402 can alight from the vehicle 10 and is an area to which the user can move from the second airplane 402 on foot. The boarding position may be in the vicinity of a trap of the second airplane 402 and may be a boarding gate of the second airplane 402.

Similarly, a user who transfers from the first airplane 401 to the second airplane 402B can move to the boarding position of the second airplane 402B by boarding the vehicle 10B after alighting from the first airplane 401. In addition, a user who transfers from the first airplane 401 to the second airplane 402C can move to the boarding position of the second airplane 402C by boarding the vehicle 10C after alighting from the first airplane 401. Note that, the vehicle 10 that a user has boarded at the alighting position of the first airplane 401 does not need to travel all the time until the boarding time of the second airplane 402 is reached. For example, the vehicle 10 that a user has boarded at the alighting position of the first airplane 401 may be kept stopped at a predetermined place (for example, parking lot) until the boarding time of the second airplane 402 is reached. In addition, the vehicle 10 that a user has boarded at the alighting position of the first airplane 401 may move around along a predetermined route until the boarding time of the second airplane 402 is reached.

The server 30 generates an operation instruction of the vehicle 10A to cause the vehicle 10A to arrive at the alighting position of the first airplane 401 at an alighting time (may be arrival time instead) of the first airplane 401 such that the user boards the vehicle 10A and to cause the vehicle 10A to arrive at the boarding position of the second airplane 402A at a boarding time (may be departure time instead) of the second airplane 402A such that the user alights from the vehicle 10A. Note that, the alighting time is a time at which the user can alight from the first airplane 401. In addition, the boarding time is a time at which the user can board the second airplane 402. Similarly, the server 30 generates an operation instruction of the vehicle 10B to cause the vehicle 10B to arrive at the alighting position of the first airplane 401 at an alighting time (may be arrival time instead) of the first airplane 401 such that the user boards the vehicle 10B and to cause the vehicle 10B to arrive at the boarding position of the second airplane 402B at a boarding time (may be departure time instead) of the second airplane 402B such that the user alights from the vehicle 10B. In addition, the server 30 generates an operation instruction of the vehicle 10C to cause the vehicle 10C to arrive at the alighting position of the first airplane 401 at an alighting time (may be arrival time instead) of the first airplane 401 such that the user boards the vehicle 10C and to cause the vehicle 10C to arrive at the boarding position of the second airplane 402C at a boarding time (may be departure time instead) of the second airplane 402C such that the user alights from the vehicle 10C.

The server 30 guides the user who transfers from the first airplane 401 to the second airplane 402A such that the user boards the vehicle 10A. Similarly, the server 30 guides the user who transfers from the first airplane 401 to the second airplane 402B such that the user boards the vehicle 10B. In addition, the server 30 guides the user who transfers from the first airplane 401 to the second airplane 402C such that the user boards the vehicle 10C. The server 30 transmits information about the vehicle 10 to board to each user terminal 20.

Hardware Configuration

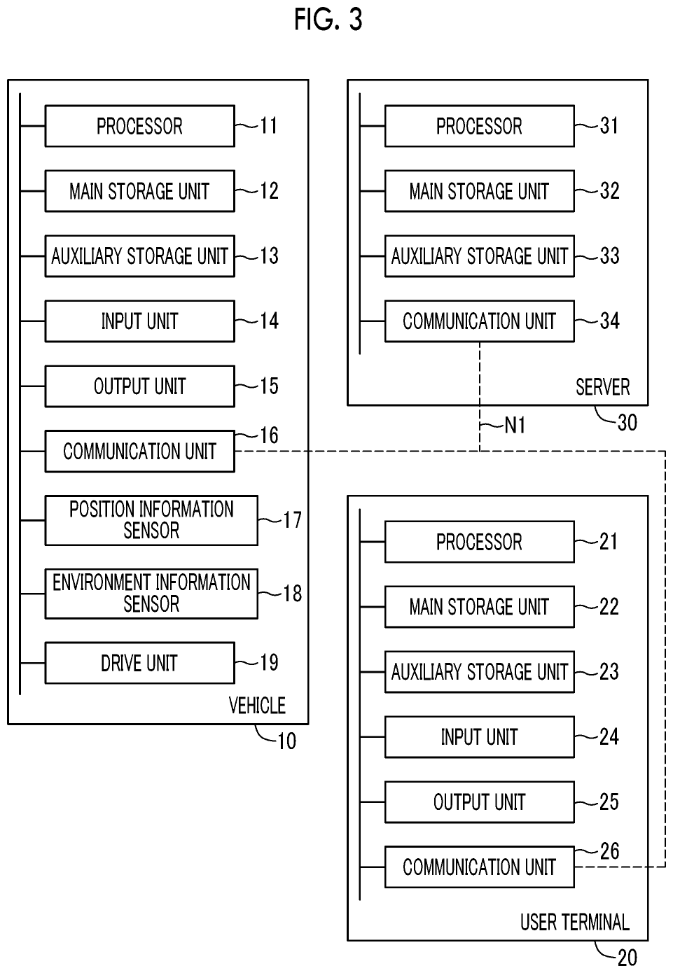

The hardware configurations of the vehicle 10, the user terminal 20, and the server 30 will be described based on FIG. 3. FIG. 3 is a block diagram schematically illustrating an example of the configurations of the vehicle 10, the user terminal 20, and the server 30 constituting the autonomous driving system 1 according to the present embodiment.

The server 30 has a configuration like that of a general computer. The server 30 includes a processor 31, a main storage unit 32, an auxiliary storage unit 33, and a communication unit 34. These are connected to each other via a bus.

The processor 31 is a central processing unit (CPU), a digital signal processor (DSP), or the like. The processor 31 controls the server 30 and performs calculation of various kinds of information processing. The processor 31 is an example of “controller”. The main storage unit 32 is a random access memory (RANI), a read only memory (ROM), or the like. The auxiliary storage unit 33 is an erasable programmable ROM (EPROM), a hard disk drive (HDD), a removable media, or the like. In the auxiliary storage unit 33, an operating system (OS), various programs, various tables, and the like are stored. The processor 31 loads the programs stored in the auxiliary storage unit 33 onto a work area of the main storage unit 32 and executes the programs and each component or the like is controlled through execution of the programs. Accordingly, a function matching a predetermined object is realized by the server 30. The main storage unit 32 and the auxiliary storage unit 33 are computer-readable recording mediums. Note that, the server 30 may be a single computer and may be a plurality of computers linked to each other. In addition, information stored in the auxiliary storage unit 33 may be stored in the main storage unit 32. In addition, information stored in the main storage unit 32 may be stored in the auxiliary storage unit 33.

The communication unit 34 is means for communicating with the vehicle 10 and the user terminal 20 via the network N1. The communication unit 34 is, for example, a local area network (LAN) interface board or a wireless communication circuit for wireless communication. The LAN interface board or the wireless communication circuit is connected to the network N1.

Note that, a series of processes performed in the server 30 may be performed by means of a hardware and may be performed by means of software. The hardware configuration of the server 30 is not limited to that shown in FIG. 3. In addition, a part or all of the components of the server 30 may be installed in the vehicle 10.

Next, the vehicle 10 will be described. The vehicle 10 includes a processor 11, a main storage unit 12, an auxiliary storage unit 13, an input unit 14, an output unit 15, a communication unit 16, a position information sensor 17, an environment information sensor 18, and a drive unit 19. These are connected to each other via a bus.

Since the processor 11, the main storage unit 12, and the auxiliary storage unit 13 are the same as the processor 31, the main storage unit 32, and the auxiliary storage unit 33 of the server 30, the description thereof will be omitted.

The input unit 14 is means for receiving an input operation performed by a user and is, for example, a touch panel, a keyboard, a mouse, a push button, or the like. The output unit 15 is means for presenting information to a user and is, for example, a liquid crystal display (LCD), an electroluminescence (EL) panel, a speaker, a lamp, or the like. The input unit 14 and the output unit 15 may be configured as one touch panel display. A user using the vehicle 10 or a user managing the vehicle 10 can use the input unit 14 and the output unit 15, for example. The communication unit 16 is communication means for connecting the vehicle 10 to the network N1. The communication unit 16 is a circuit for communicating with another device (for example, server 30) via the network N1 by means of a vehicle communication service (telephone communication network such as 3rd Generation (3G) and long term evolution (LTE) and wireless communication such as WiFi).

The position information sensor 17 acquires position information (latitude and longitude, for example) of the vehicle 10 each time a predetermined period elapses. The position information sensor 17 is, for example, a global positioning system (GPS) receiver, a WiFi communication unit, or the like. Information acquired by the position information sensor 17 is recorded in the auxiliary storage unit 13 or the like and is transmitted to the server 30.

The environment information sensor 18 is means for sensing the state of the vehicle 10 or sensing the vicinity of the vehicle 10. Examples of a sensor for sensing the state of the vehicle 10 include an acceleration sensor, a speed sensor, and an azimuth sensor. Examples of a sensor for sensing the vicinity of the vehicle 10 include a stereo camera, a laser scanner, a LIDAR device, and a radar.

The drive unit 19 causes the vehicle 10 to travel based on a control instruction generated by the processor 11. The drive unit 19 is configured to include, for example, a motor or an inverter, a brake, a steering mechanism and the like for driving vehicle wheels of the vehicle 10 and autonomous travel of the vehicle 10 is realized with the motor, the brake, or the like being driven in accordance with the control instruction.

Next, the user terminal 20 will be described. The user terminal 20 is a small computer such as a smartphone, a cellular phone, a tablet terminal, a personal information terminal, a wearable computer (such as smart watch), and a personal computer (PC). The user terminal 20 includes a processor 21, a main storage unit 22, an auxiliary storage unit 23, an input unit 24, an output unit 25, and a communication unit 26. These are connected to each other via a bus. Since the processor 21, the main storage unit 22, the auxiliary storage unit 23, the input unit 24, the output unit 25, and the communication unit 26 are the same as the processor 11, the main storage unit 12, the auxiliary storage unit 13, the input unit 14, the output unit 15, and the communication unit 16 of the vehicle 10, the description thereof will be omitted.

Functional Configuration: Server

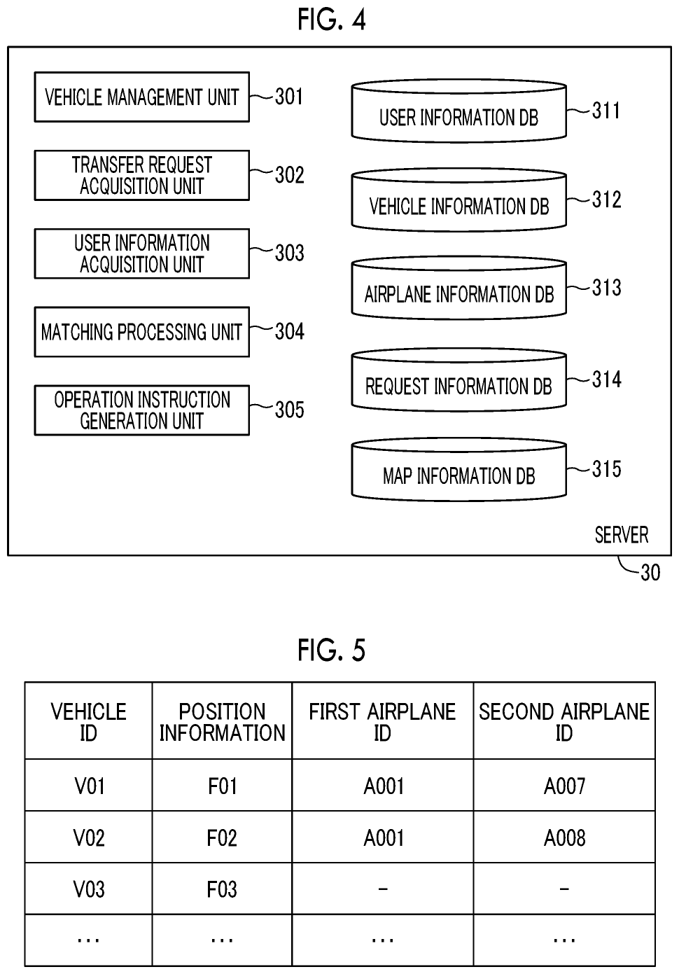

FIG. 4 is a diagram illustrating an example of the functional configuration of the server 30. The server 30 includes a vehicle management unit 301, a transfer request acquisition unit 302, a user information acquisition unit 303, a matching processing unit 304, an operation instruction generation unit 305, a user information DB 311, a vehicle information DB 312, an airplane information DB 313, a request information DB 314, and a map information DB 315 as functional constituent elements. The vehicle management unit 301, the transfer request acquisition unit 302, the user information acquisition unit 303, the matching processing unit 304, and the operation instruction generation unit 305 are functional constituent elements provided when the processor 31 of the server 30 executes various programs stored in the auxiliary storage unit 33, for example.

The user information DB 311, the vehicle information DB 312, the airplane information DB 313, the request information DB 314, and the map information DB 315 are, for example, relational databases organized when a database management system (DBMS) program executed by the processor 31 manages data stored in the auxiliary storage unit 33. Note that, any of the functional constituent elements of the server 30 or a part of processes thereof may be executed by another computer connected to the network N1.

The vehicle management unit 301 manages various items of information relating to the vehicle 10. The vehicle management unit 301 acquires and manages position information that is transmitted from the vehicle 10 each time a predetermined period elapses or position information that is transmitted from the vehicle 10 in response to a request from the server 30. The vehicle management unit 301 stores position information into the vehicle information DB 312 with the position information being correlated with a vehicle ID.

The transfer request acquisition unit 302 acquires a transfer request from a user who wants to make a transfer. The transfer request is information including an identifier for the user and is information for requesting that the user be matched with the vehicle 10 for a transfer. The transfer request includes information about the first airplane 401 from which the user transfers and information about the second airplane 402 to which the user transfers. The transfer request is generated in the user terminal 20 when the user performs a predetermined inputting operation on the input unit 24 of the user terminal 20. The transfer request is transmitted from the user terminal 20 to the server 30.

The user information acquisition unit 303 acquires information (user information) about the user who transmits the transfer request. The user information includes information about a user ID. The user ID is an identifier unique to the user and is associated with the user. The user information (for example, name, address, telephone number, and e-mail address) corresponding to the user ID may be registered in advance by the user using the user terminal 20 or may be transmitted from the user terminal 20 together with the transfer request. The user information is stored in the user information DB 311 which will be described later.

The matching processing unit 304 matches the user with the vehicle 10. The matching processing unit 304 searches for the vehicle 10 of which the departure point is the alighting position of the first airplane 401 corresponding to the transfer request and of which the destination is the boarding position of the second airplane 402 corresponding to the transfer request, while referring to the departure point and the destination of each vehicle 10. Note that, in a case where there is no vehicle 10 that moves along a route from the first airplane 401 corresponding to the transfer request to the second airplane 402 corresponding to the transfer request, the matching processing unit 304 selects the vehicle 10 newly and matches the selected vehicle 10 with the user.

The operation instruction generation unit 305 generates an operation instruction such that the vehicle 10 departs from the alighting position of the first airplane 401 and arrives at the boarding position of the second airplane 402. Note that, the operation instruction generation unit 305 according to the present embodiment generates a moving route based on map information stored in the map information DB 315, which will be described later. The alighting position and the alighting time of the first airplane 401 and the boarding position and the boarding time of the second airplane 402 are provided from a server of an airline company, for example. Note that, although depending on the length of a time from the alighting time of the first airplane 401 to the boarding time of the second airplane 402, the vehicle 10 may be parked in a parking lot on the way. The moving route is generated such that the moving route becomes a route according to a rule determined in advance. The operation instruction generation unit 305 transmits the operation instruction including the moving route to the vehicle 10.

The user information DB 311 is formed with user information of users stored in the auxiliary storage unit 33 and in the user information DB 311, each user is associated with user information. User information includes, for example, a user ID, a name, an address, or the like associated with a user.

The vehicle information DB 312 is formed with vehicle information stored in the auxiliary storage unit 33 and in the vehicle information DB 312, a vehicle ID and vehicle information are associated with each other. Here, the configuration of the vehicle information stored in the vehicle information DB 312 will be described based on FIG. 5. FIG. 5 is a diagram illustrating a table configuration of the vehicle information. The vehicle information DB 312 includes fields for a vehicle ID, position information, a first airplane ID, and a second airplane ID corresponding to each vehicle 10. In a vehicle ID field, identification information for specifying the vehicle 10 is input. In a position information field, position information transmitted from the vehicle 10 is input. The position information is information indicating the current position of the vehicle 10. In a first airplane ID field, identification information (for example, information about flight number) for specifying the first airplane 401 corresponding to the vehicle 10 is input. In a second airplane ID field, identification information (for example, information about flight number) for specifying the airplane ID of the second airplane 402 corresponding to the vehicle 10 is input. A first airplane ID field and a second airplane ID field of the vehicle 10 not operated for making a transfer are made blank.

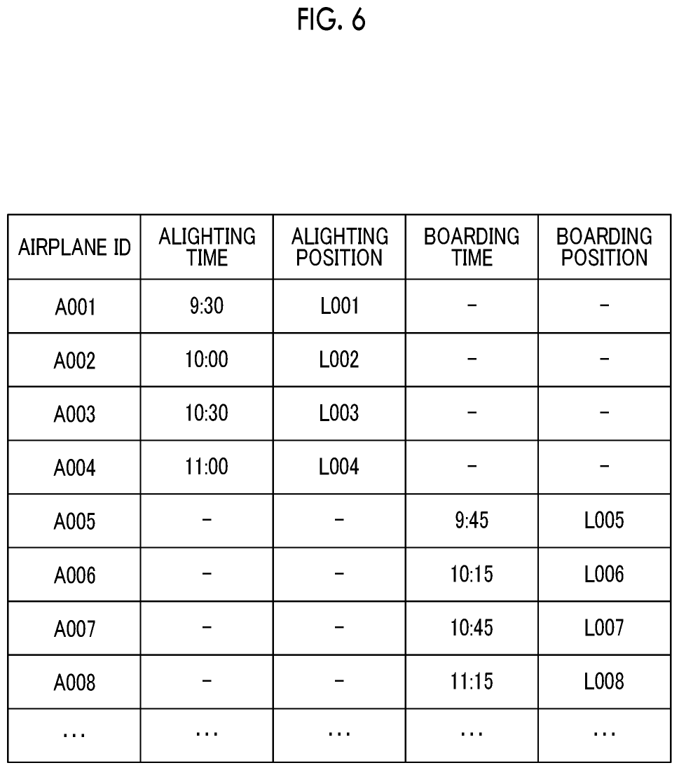

The airplane information DB 313 is formed with information (hereinafter, may be simply referred to as “airplane information”) about an airplane transfer stored in the auxiliary storage unit 33. Here, the configuration of the airplane information stored in the airplane information DB 313 will be described based on FIG. 6. FIG. 6 is a diagram illustrating a table configuration of the airplane information. An airplane information table includes fields for airplane IDs, alighting times (may be arrival times instead), alighting positions, boarding times (may be departure times instead), and boarding positions. As an airplane ID, information (for example, information about flight number) for specifying an airplane is input. As an alighting time, information about a time at which a user alights from an airplane is input. Note that, information about a time at which an airplane arrives at an airport may be input instead of an alighting time. As an alighting position, information about a position where a user alights from an airplane and the user boards the vehicle 10 is input. As a boarding time, information about a time at which a user boards an airplane is input. Note that, information about a time at which an airplane departs from an airport may be input instead of a boarding time. As a boarding position, information about a position where a user boards an airplane and the user alights from the vehicle 10 is input. The above-described information items may be information provided from a server of each airline company and may be information input to the user terminal 20 by a user.

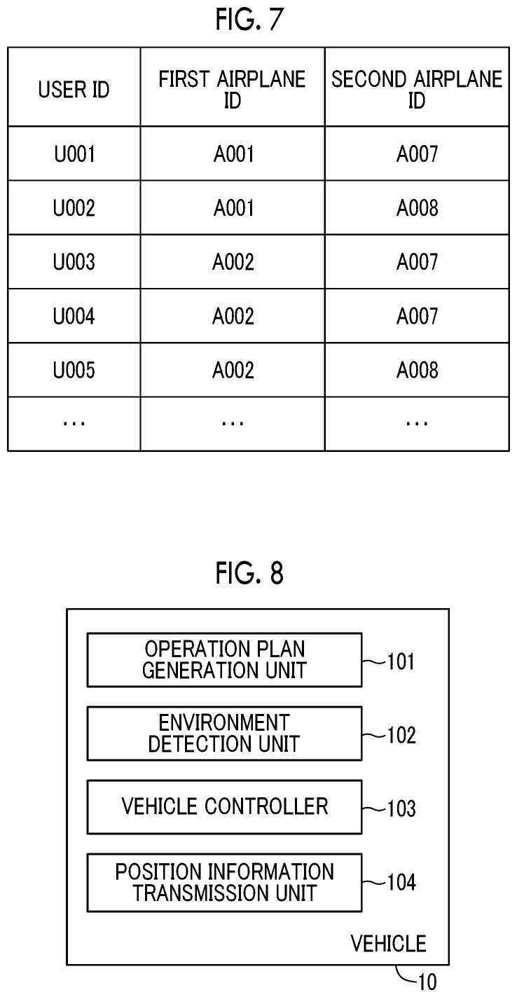

The request information DB 314 is formed with information (hereinafter, may be referred to as request information) about a transfer request stored in the auxiliary storage unit 33. Here, the configuration of the request information stored in the request information DB 314 will be described based on FIG. 7. FIG. 7 is a diagram illustrating a table configuration of the request information. A request information table includes fields for user IDs, first airplane IDs, and second airplane IDs. In a user ID field, information for specifying a user is input. In a first airplane ID field, information about the airplane ID of a first airplane that a user boards is input. In a second airplane ID field, information about the airplane ID of a second airplane that a user boards is input. The above-described information items are transmitted from the user terminal 20 together with a transfer request.

In the map information DB 315, map information including map data and point of interest (POI) information such as texts or photographs indicating the features of each point in the map data is stored. Note that, the map information DB 315 may be provided from another system connected to the network N1 (for example, geographic information system (GIS)).

Functional Configuration: Vehicle

FIG. 8 is a diagram illustrating an example of the functional configuration of the vehicle 10. The vehicle 10 includes an operation plan generation unit 101, an environment detection unit 102, a vehicle controller 103, and a position information transmission unit 104 as functional constituent elements. The operation plan generation unit 101, the environment detection unit 102, the vehicle controller 103, and the position information transmission unit 104 are functional constituent elements provided when the processor 11 of the vehicle 10 executes various programs stored in the auxiliary storage unit 13, for example.

The operation plan generation unit 101 acquires an operation instruction from the server 30 and generates an operation plan of the vehicle 10. The operation plan generation unit 101 calculates a moving route of the vehicle 10 based on the operation instruction from the server 30 and generates an operation plan of moving along the moving route.

The environment detection unit 102 detects the surrounding environment around the vehicle 10 needed for autonomous travel based on data acquired by the environment information sensor 18. Examples of a target to be detected include the number of lanes or the positions of lanes, the number of other vehicles present in the vicinity of the vehicle 10 or the positions of the other vehicles, the number of obstacles (for example, pedestrian, bicycle, structure, and building) present in the vicinity of the vehicle 10 or the positions of the obstacles, the structure of a road, and a traffic sign. However, the target to be detected is not limited thereto. The target to be detected may be any type of target that needs to be detected for autonomous travel. For example, in a case where the environment information sensor 18 is a stereo camera, data of an image captured by the stereo camera is subject to image processing such that an object in the vicinity of the vehicle 10 is detected. Data about the surrounding environment around the vehicle 10 detected by the environment detection unit 102 (hereinafter, referred to as environment data) is transmitted to the vehicle controller 103 which will be described later.

The vehicle controller 103 generates a control instruction to control autonomous travel of the vehicle 10 based on an operation plan generated by the operation plan generation unit 101, environment data generated by the environment detection unit 102, and position information of the vehicle 10 acquired by the position information sensor 17. For example, the vehicle controller 103 generates the control instruction such that the vehicle 10 travels along a predetermined route and travels without an obstacle entering a predetermined safety area centering on the vehicle 10. The generated control instruction is transmitted to the drive unit 19. As a method of generating a control instruction for causing the vehicle 10 to autonomously travel, a known method can be adopted.

The position information transmission unit 104 transmits the position information acquired from the position information sensor 17 to the server 30 via the communication unit 16. The timing of transmission of the position information from the position information transmission unit 104 can be appropriately set. For example, the transmission may be performed periodically, may be performed at the timing of transmission of some information to the server 30, and may be performed in response to a request from the server 30. The position information transmission unit 104 transmits the position information to the server 30 along with identification information (vehicle ID) for uniquely identifying the host vehicle. Note that, a vehicle ID for identifying the vehicle 10 is assigned in advance.

Functional Configuration: User Terminal

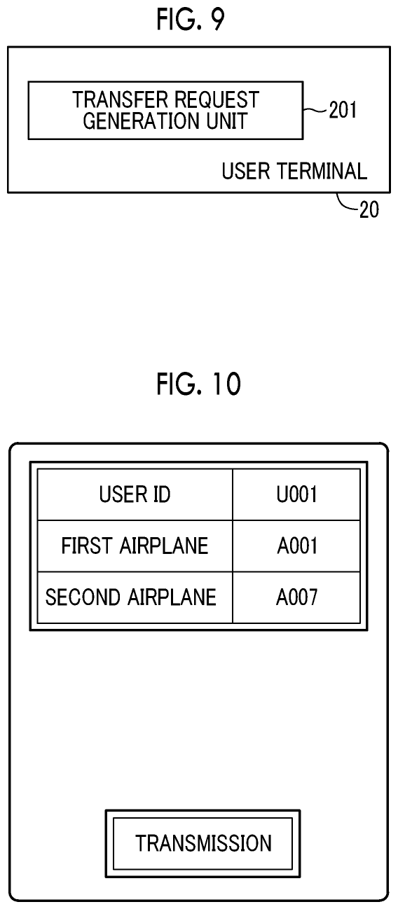

FIG. 9 is a diagram illustrating an example of the functional configuration of the user terminal 20. The user terminal 20 includes a transfer request generation unit 201 as a functional constituent element. The transfer request generation unit 201 is a functional constituent element provided when the processor 21 of the user terminal 20 executes various programs stored in the auxiliary storage unit 23, for example.

The transfer request generation unit 201 causes the output unit 25 to display an operation screen that prompts a user to input a transfer request and generates the transfer request corresponding to an input operation that is performed on the input unit 24 by the user. For example, the transfer request generation unit 201 outputs, on a touch panel display of the user terminal 20, an icon or the like for a request to board the vehicle 10 to make a transfer and generates a transfer request in a case where the user clicks the icon. The transfer request includes information about the first airplane 401 and the second airplane 402. The transfer request generation unit 201 transmits the generated transfer request to the server 30 with the transfer request being associated with a user ID.

FIG. 10 is a diagram illustrating an example of a screen that is displayed on the output unit 25 of the user terminal 20 when a user makes a request to board the vehicle 10 to make a transfer. The user inputs text for each of a user ID field, a first airplane field, and a second airplane field. Thereafter, when the user clicks “transmission”, the transfer request generation unit 201 generates a transfer request and transmits the transfer request to the server 30.

Flow of Process: Server

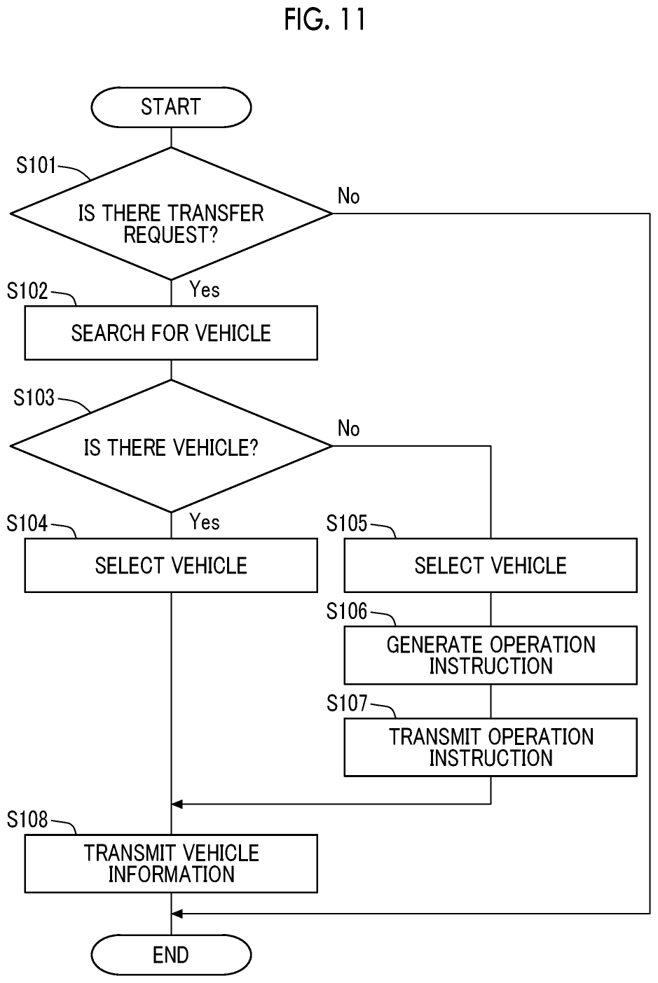

Next, a process in which the server 30 matches a user with the vehicle 10 will be described. FIG. 11 is an example of a flowchart of the process of matching a user with the vehicle 10 according to the present embodiment. The process shown in FIG. 11 is performed by the processor 31 of the server 30 each time a predetermined time elapses. Note that, here, it will be assumed that the server 30 has already acquired information needed for organization of the user information DB 311, the vehicle information DB 312, the airplane information DB 313, the request information DB 314, and the map information DB 315.

In step S101, determination is made on whether or not the transfer request acquisition unit 302 has received a transfer request from the user terminal 20. In a case where the result of the determination in step S101 is positive, the process proceeds to step S102 and in a case where the result of the determination in step S101 is negative, the present routine is terminated.

In step S102, the matching processing unit 304 searches for the vehicle 10 that is needed for making a transfer relating to the transfer request. The matching processing unit 304 accesses the request information DB 314 to acquire a first airplane ID and a second airplane ID corresponding to a user ID of a user relating to the transfer request. In addition, the matching processing unit 304 accesses the vehicle information DB 312 and when there is a vehicle ID corresponding to the first airplane ID and the second airplane ID, the matching processing unit 304 acquires the vehicle ID.

In step S103, the matching processing unit 304 determines whether or not there is a vehicle ID acquired in step S102. In step S103, determination is made on whether or not the vehicle 10 corresponding to the user exists. In a case where the result of the determination in step S103 is positive, the process proceeds to step S104 and the vehicle 10 corresponding to the acquired vehicle ID is selected as the vehicle 10 that the user boards when making a transfer. In this case, a plurality of users who transfers to the same second airplane 402 is matched with the same vehicle 10.

Meanwhile, In a case where the result of the determination in step S103 is negative, the process proceeds to step S105. In step S105, the matching processing unit 304 newly selects the vehicle 10 corresponding to the first airplane ID and the second airplane ID. When there is no vehicle ID corresponding to the first airplane ID and the second airplane ID, the matching processing unit 304 selects the vehicle 10, for which a first airplane ID field and a second airplane ID field are blank in the vehicle information

DB 312, as the vehicle 10 that the user boards when making a transfer. Then, the matching processing unit 304 updates a first airplane ID field and a second airplane ID field in the vehicle information DB 312 that correspond to the selected vehicle 10.

In step S106, the operation instruction generation unit 305 generates an operation instruction of the vehicle 10. The operation instruction generation unit 305 generates, while referring to the airplane information DB 313, the operation instruction to cause the vehicle 10 to move to an alighting position until the alighting time of the first airplane 401 such that the user boards the vehicle 10 at the alighting position and to move to a boarding position until the boarding time of the second airplane 402 such that the user alights from the vehicle 10 at the boarding position. Then, in step S107, the operation instruction generation unit 305 transmits the operation instruction to the vehicle 10 selected in step S105.

Next, in step S108, the operation instruction generation unit 305 transmits information about the vehicle 10 selected in step S104 or step S105 to the user terminal 20. The information about the vehicle 10 mentioned here is information with which the user can identify the vehicle 10 and is, for example, information about a number or a name posted on the vehicle 10.

Flow of Process: Vehicle

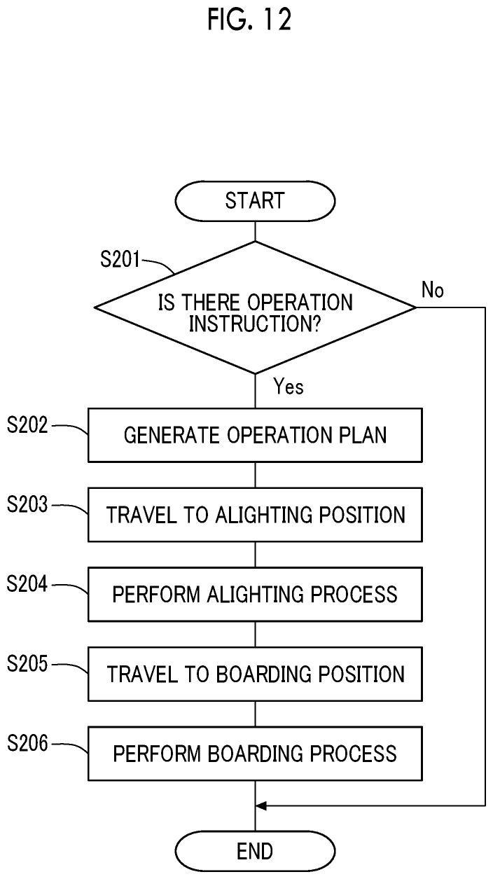

Next, a process of causing the vehicle 10 to travel will be described. FIG. 12 is an example of a flowchart of the process of causing the vehicle 10 according to the present embodiment to travel. The process shown in FIG. 12 is performed by the processor 11 of the vehicle 10 each time a predetermined time elapses.

In step S201, determination on whether the operation plan generation unit 101 has received an operation instruction from the server 30 or not is performed. In a case where the result of the determination in step S201 is positive, the process proceeds to step S202 and in a case where the result of the determination in step S201 is negative, the present routine is terminated. In step S202, the operation plan generation unit 101 generates an operation plan in accordance with the operation instruction.

When generation of the operation plan is finished, in step S203, the vehicle controller 103 generates a control instruction, the drive unit 19 is controlled by the control instruction, and the vehicle 10 travels to the alighting position of the first airplane 401. The operation plan generation unit 101 generates the operation plan such that the vehicle 10 becomes not late for the alighting time of the first airplane 401 and thus the vehicle 10 arrives at the alighting position until the alighting time of the first airplane 401.

In step S204, the vehicle controller 103 performs an alighting process. The alighting process is a process for causing a user alighting from the first airplane 401 to board the vehicle 10 and includes, for example, opening and closing a door, locking and unlocking the door, and outputting a voice prompting the user to board the vehicle 10.

The alighting process includes keeping the vehicle 10 stopped at the alighting position until all of users scheduled to board the vehicle 10 board the vehicle 10. For example, the communication unit 16 of the vehicle 10 and the communication units 26 of the user terminals 20 may perform short-range communication to check whether or not all of the users scheduled to board the vehicle 10 have boarded the vehicle 10. In addition, when the users board the vehicle 10, the input unit 14 of the vehicle 10 may read airplane tickets or screens on the user terminals 20 to check the users. In addition, a motion detector may be attached to the vehicle 10 and a determination may be made that all of the users scheduled to board the vehicle 10 have boarded the vehicle 10 in a case where the number of persons counted by the motion detector reaches the number of the users scheduled to board the vehicle 10. In addition, the users scheduled to board the vehicle 10 may be considered to all have boarded the vehicle 10 in a case where the vehicle 10 is kept stopped at the alighting position for a time sufficient for the users to board the vehicle 10.

In step S205, the vehicle controller 103 generates a control instruction, the drive unit 19 is controlled by the control instruction, and the vehicle 10 travels to the boarding position of the second airplane 402. The operation plan generation unit 101 generates the operation plan such that the vehicle 10 becomes not late for the boarding time of the second airplane 402 and thus the vehicle 10 arrives at the boarding position until the boarding time of the second airplane 402.

In step S206, the vehicle controller 103 performs a boarding process. The boarding process is a process for causing a user boarding the second airplane 402 to alight from the vehicle 10 and includes, for example, opening and closing a door, locking and unlocking the door, and outputting a voice prompting the user to alight from the vehicle 10. The boarding process includes keeping the vehicle 10 stopped at the boarding position until all of users alight from the vehicle 10. For example, the communication unit 16 of the vehicle 10 and the communication units 26 of the user terminals 20 may perform short-range communication to confirm whether or not all of the users have alighted from the vehicle 10. In addition, a motion detector may be attached to the vehicle 10 and a determination may be made that all of the users have alighted from the vehicle 10 in a case where the motion detector detects no person in the vehicle 10. In addition, the users may be considered to all have alighted from the vehicle 10 in a case where the vehicle 10 is kept stopped at the boarding position for a time sufficient for the users to alight from the vehicle 10.

As described above, according to the present embodiment, it is possible to transfer from the first airplane 401 to the second airplane 402 by means of the vehicle 10 which autonomously travels. Accordingly, a user does not need to manage a boarding time and a boarding position of an airplane to which the user transfers. Therefore, an airplane transfer is simplified for the user.

### Second Embodiment

In the present embodiment, even in the case of users who transfer from the same first airplane 401 to the same second airplane 402, the vehicles 10 are distributed according to the attributes of the users. For example, the users are matched with the vehicles 10 such that a smoker and a non-smoker board the vehicles 10 different from each other. Then, smoking is permitted in the vehicle 10 that the smoker boards and smoking is not permitted in the vehicle 10 that the non-smoker boards. In addition, for example, the users are matched with the vehicles 10 such that a group with a child and a person or a group with no child board the vehicles 10 different from each other. The vehicle 10 that the group with the child boards is provided with a bed on which a child lies down, a bed at which it is possible to change diapers, or the like. In addition, for example, food and drink preferred by children are provided. Meanwhile, the vehicle 10 that the person or the group with no child boards is provided with food and drink preferred by adults. In addition, for example, the users are matched with the vehicles 10 such that a person of which purpose of visit is business and a person of which purpose of visit is sightseeing board the vehicles 10 different from each other. Then, in the vehicle 10 that the person of which purpose of visit is business boards, for example, a table is provided. Meanwhile, in the vehicle 10 that the person of which purpose of visit is sightseeing boards, a music is played or sightseeing information is provided. In the present embodiment, a plurality of kinds of the vehicles 10 corresponding to the attributes of the users are prepared in advance.

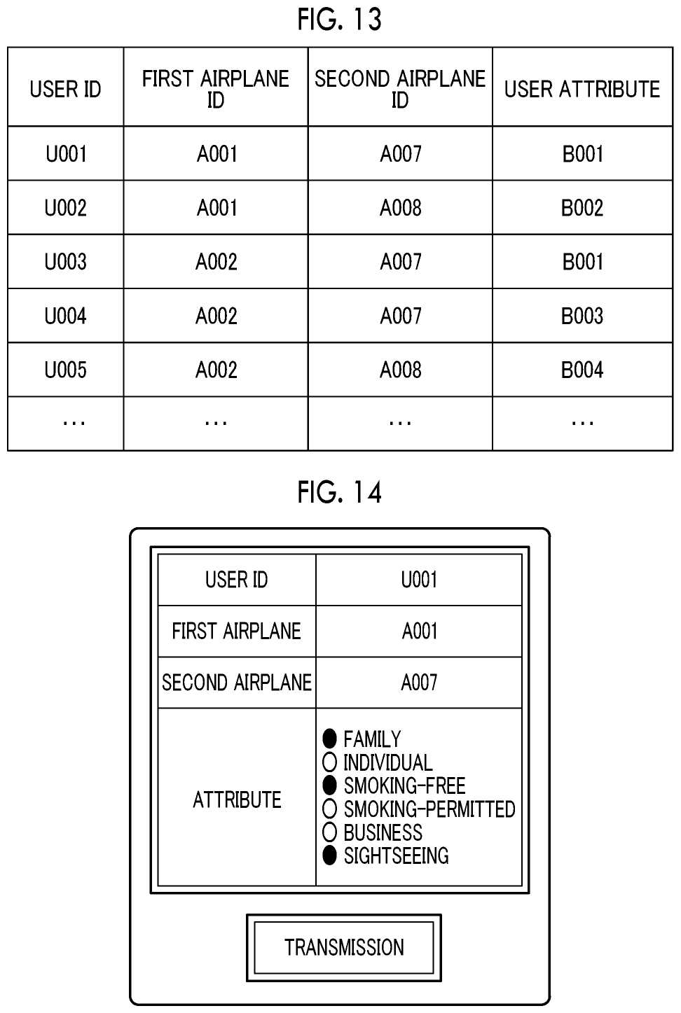

The attributes of users are included in user information and are transmitted from the user terminals 20 to the server 30. The attributes of users that are registerable in the server 30 are determined in advance. The user information acquisition unit 303 of the server 30 stores the attributes of the user in the request information DB 314. Here, the configuration of request information stored in the request information DB 314 in the present embodiment will be described based on FIG. 13. FIG. 13 is a diagram illustrating a table configuration of the request information. A request information table includes fields for user IDs, first airplane IDs, second airplane IDs, and attributes. In a user ID field, a first airplane ID field, and a second airplane ID field, the same information as in FIG. 7 is input. In addition, in an attribute field, information about the attribute of a user is input. For example, information with which it is possible to distinguish between a family with a child and an individual, to distinguish between a smoker and a non-smoker, and to distinguish between a user of which purpose is business and a user of which purpose is sightseeing is input. The above-described information items are transmitted from the user terminal 20 together with a transfer request. Note that, selection of the vehicle 10 corresponding to an attribute that is input to the user terminal 20 by a user may not be performed. In a case where there is an insufficient number of the vehicles 10, users of different attributes may board the same vehicle 10.

Note that, the attribute of a user is not limited to those above described and may be, for example, the degree of fatigue of the user or the health status of the user.

In addition, the attribute of a user may be whether or not the user is a disabled person or the state or degree of a disability. In addition, the attribute of a user may be set based on whether the user has a package or the size of the package. In addition, the attribute of a user may be set in accordance with what the user wants to do when making a transfer. For example, users who want to perform sightseeing when making a transfer may be matched with the same vehicle 10 such that the users perform sightseeing by means of the vehicle 10. In this case, a sightseeing route may be set in accordance with the length of a time from the alighting time of the first airplane 401 to the boarding time of the second airplane 402. In addition, for example, a user who wants to take a shower when making a transfer may be matched with the vehicle 10 provided with a shower room.

FIG. 14 is a diagram illustrating an example of a screen that is displayed on the output unit 25 of the user terminal 20 when a user makes a request to board the vehicle 10 to make a transfer. The user inputs text for each of a user ID field, a first airplane field, and a second airplane field. In addition, regarding the attribute of the user, the user clicks a radio button for an item corresponding to the attribute of the user. Thereafter, when the user clicks “transmission”, the transfer request generation unit 201 generates a transfer request and transmits the transfer request to the server 30.

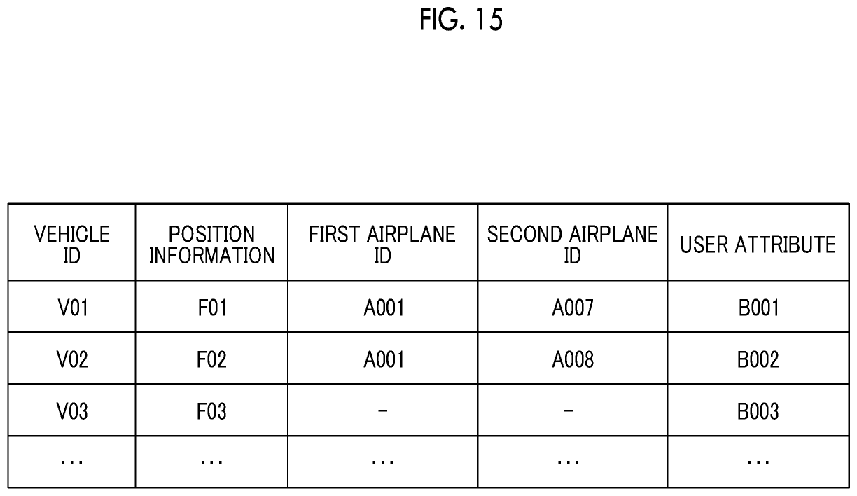

In addition, the configuration of the vehicle information stored in the vehicle information DB 312 according to the present embodiment will be described based on FIG. 15. FIG. 15 is a diagram illustrating a table configuration of the vehicle information. The vehicle information DB 312 includes fields for a vehicle ID, position information, a first airplane ID, a second airplane ID, and a user attribute corresponding to each vehicle 10. Vehicle ID fields, position information fields, first airplane ID fields, and second airplane ID fields are the same as those in FIG. 5 and thus the description thereof will be omitted. In a user attribute field, information about a user attribute corresponding to the vehicle 10 is input. Note that, one vehicle 10 may correspond to a plurality of user attributes.

### Flow of Process: Server

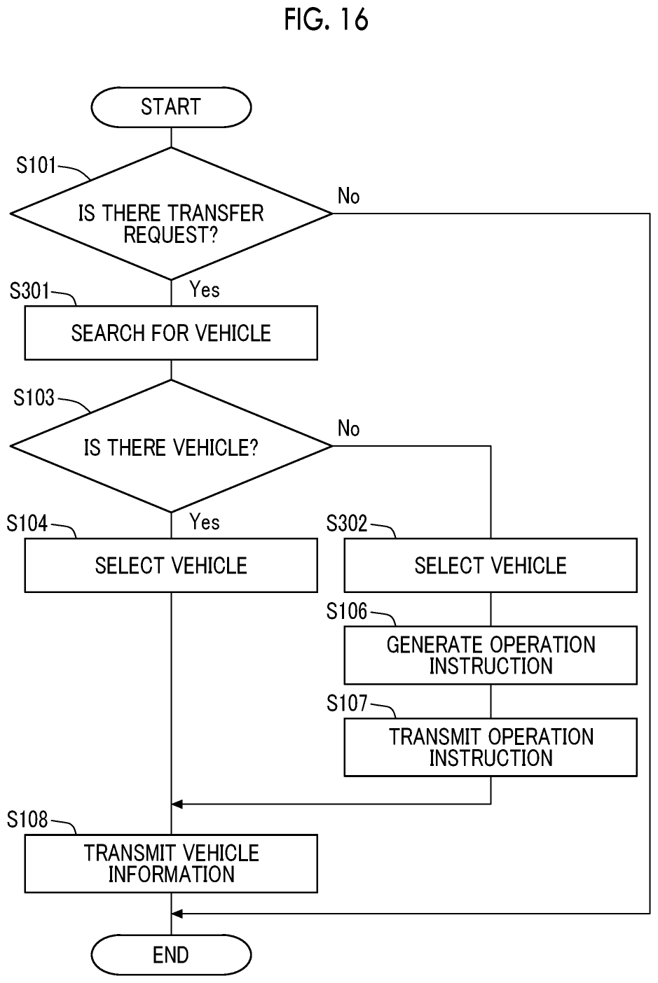

Next, a process in which the server 30 matches a user with the vehicle 10 will be described. Note that, the flow of a process in the vehicle 10 is the same as that in the first embodiment and thus the description thereof will be omitted. FIG. 16 is an example of a flowchart of the process of matching a user with the vehicle 10 according to the present embodiment. The process shown in FIG. 16 is performed by the processor 31 of the server 30 each time a predetermined time elapses. A point different from the flowchart shown in FIG. 11 will be described. Processing in step S301 and step S302 in the flowchart of the process of matching a user with the vehicle 10 according to the present embodiment is different from that in the flowchart shown in FIG. 11.

In step S301 in the present embodiment, the matching processing unit 304 searches for the vehicle 10 that is needed for making a transfer relating to the transfer request. At this time, the matching processing unit 304 accesses the request information DB 314 to acquire a first airplane ID, a second airplane ID, and a user attribute corresponding to a user ID of a user relating to the transfer request. In addition, the matching processing unit 304 accesses the vehicle information DB 312 and when there is a vehicle ID corresponding to the first airplane ID, the second airplane ID, and the user attribute, the matching processing unit 304 acquires the vehicle ID.

In addition, in step 5302 in the present embodiment, the matching processing unit 304 newly selects the vehicle 10 corresponding to the first airplane ID, the second airplane ID, and the user attribute. When there is no vehicle ID corresponding to the first airplane ID, the second airplane ID, and the user attribute, the matching processing unit 304 selects the vehicle 10, for which the first airplane ID field and the second airplane ID field are blank in the vehicle information DB 312 and which corresponds to a user attribute coinciding with the user attribute relating to the transfer request, as the vehicle 10 that the user boards when making a transfer. Then, the matching processing unit 304 updates a first airplane ID field and a second airplane ID field in the vehicle information DB 312 that correspond to the selected vehicle 10.

As described above, according to the present embodiment, it is possible to transfer from the first airplane 401 to the second airplane 402 by means of the vehicle 10 which autonomously travels. At this time, it is possible to make a transfer by using the appropriate vehicle 10 matching the attribute of a user. In addition, it is possible to effectively use a time when making a transfer. Accordingly, it is possible to improve user convenience.

### Other Embodiments

The above-described embodiments are merely examples and the disclosure can be implemented with appropriate modifications without departing from the gist of the disclosure.

The processes or means described in the disclosure can be freely combined with each other as long as there is no technical contradiction.

In addition, a process that has been described as a process performed by one device may be divided up and performed by a plurality of devices. Alternatively, a process that has been described as a process performed by different devices may be performed by one device. It is possible to flexibly change with what kind of hardware configuration (server configuration) each function is realized in a computer system. In the above-described embodiments, the server 30 includes the vehicle management unit 301, the transfer request acquisition unit 302, the user information acquisition unit 303, the matching processing unit 304, the operation instruction generation unit 305, the user information DB 311, the vehicle information DB 312, the airplane information DB 313, the request information DB 314, and the map information DB 315 as functional constituent elements. However, a part or all of the functional constituent elements may be included in the vehicle 10.

The disclosure also can be realized when a computer program, in which the functions described in the above-described embodiments are mounted, is supplied to a computer and one or more processors of the computer reads and executes the program. Such a computer program may be provided to a computer via a non-transitory computer-readable storage medium that can be connected to a system bus of the computer and may be provided to the computer via a network. Examples of the non-transitory computer-readable storage medium include any type of disk such as a magnetic disk (floppy (registered trademark) disk, hard disk drive (HDD), or like) and an optical disk (CD-ROM, DVD disk, Blu-ray disk, or like), a read only memory (ROM), a random access memory (RAM), an EPROM, an EEPROM, a magnetic card, a flash memory, an optical card, and any type of medium suitable for storing electronic commands.

What is claimed is:

1. An information processing apparatus comprising a controller configured to
acquire information about a first airplane from which a user transfers and information about a second airplane to which the user transfers in a case where the user who makes an airplane transfer in an airport makes a request to use an autonomously traveling vehicle when the user moves from the first airplane to the second airplane,
match the user with the vehicle based on the information about the first airplane and the information about the second airplane, and
generate an operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle.

2. The information processing apparatus according to claim 1, wherein, in a case where there is a plurality of users transferring from the first airplane and there is a plurality of the second airplanes to which the users are able to transfer from the first airplane, the controller matches the users with vehicles such that users who transfer to the same second airplane board the same vehicle.

3. The information processing apparatus according to claim 1, wherein the controller acquires information about an attribute of the user and matches the user with the vehicle based on the information about the attribute of the user in addition to the information about the first airplane and the information about the second airplane.

4. The information processing apparatus according to claim 3, wherein, in a case where there is a plurality of users transferring from the first airplane and there is a plurality of the second airplanes to which the users are able to transfer from the first airplane, the controller matches the users with vehicles such that users who transfer to the same second airplane and have the same attribute board the same vehicle.

5. The information processing apparatus according to claim 1, wherein:
the information about the first airplane includes information about the time at which the user alights from the first airplane and information about the position where the user alights from the first airplane; and
the information about the second airplane includes information about the time at which the user boards the second airplane and information about the position where the user boards the second airplane.

6. An information processing method comprising causing a computer to
acquire information about a first airplane from which a user transfers and information about a second airplane to which the user transfers in a case where the user who makes an airplane transfer in an airport makes a request to use an autonomously traveling vehicle when the user moves from the first airplane to the second airplane,
match the user with the vehicle based on the information about the first airplane and the information about the second airplane, and
generate an operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle.

7. A program causing a computer to
acquire information about a first airplane from which a user transfers and information about a second airplane to which the user transfers in a case where the user who makes an airplane transfer in an airport makes a request to use an autonomously traveling vehicle when the user moves from the first airplane to the second airplane,
match the user with the vehicle based on the information about the first airplane and the information about the second airplane, and
generate an operation instruction to dispose the vehicle at a position where the user alights from the first airplane in accordance with a time at which the user alights from the first airplane such that the user boards the vehicle and to dispose the vehicle at a position where the user boards the second airplane in accordance with a time at which the user boards the second airplane such that the user alights from the vehicle.
